(19) United States
(12) Patent Application Publication
(10) Pub. No.: US 2016/0043924 A1
(43) Pub. Date: Feb. 11, 2016

(54) SYSTEM AND METHOD FOR MONITORING USER ACTIVITY ON A PLURALITY OF NETWORKED COMPUTING DEVICES

(71) Applicant: MICROPACE PTY LIMITED, New South Wales (AU)

(72) Inventors: Michael Cejnar, New South Wales (AU); David Laurence Hellier, New South Wales (AU); Petri Ilari Nuuttila, New South Wales (AU)

(21) Appl. No.: 14/775,486

(22) PCT Filed: Mar. 14, 2014
(86) PCT No.: PCT/AU2014/000277

§ 371 Date: Sep. 11, 2015

Related U.S. Application Data
(60) Provisional application No. 61/789,468, filed on Mar. 15, 2013.

(51) Int. Cl. H04L 12/26; H04L 29/08

(52) U.S. Cl. CPC H04L 43/0876; H04L 43/10; H04L 67/22

(57) ABSTRACT

Among other things, we describe monitoring and interactively supervising user activity on a plurality of networked computing devices. Some embodiments relate to methods and systems configured for remote automatic selection and monitoring of a most actively used computer device from among a plurality of computer devices accessible to and logged into by a specific user. Such methods and systems may also involve the display of the user's screen on a dedicated monitoring display device. Where multiple users are monitored, the displays of the user devices that are most actively used may be reproduced on the monitoring device display in dedicated view ports for the users being monitored. Embodiments may involve the use of software agents installed and executing on each user device that is turned on. Such software agents assist in allowing the monitoring device to determine which of the user devices is most actively used by a particular user.

### CROSS-REFERENCE TO RELATED APPLICATIONS

This application is a §371 National Stage application of International Application No. PCT/AU2014/000277, filed on Mar. 14, 2014, which claims the benefit of priority under 35 U.S.C. §119(e) of U.S. Patent Application No. 61/789,468, filed on Mar. 15, 2013. The disclosure of each of the foregoing applications is incorporated herein by reference.

### TECHNICAL FIELD

Described embodiments relate generally to systems and methods for monitoring user activity on a plurality of networked computing devices.

### BACKGROUND

Digital activities occupy the majority of the waking lives of many people. Problematic use of digital devices and the internet is a growing social problem for parents, teachers and employers alike. Users requiring supervision, such as children, increasingly use a variety of devices from desktop computers to mobile tablet computers to smartphones, as well as dedicated game platforms for both learning and entertainment, making supervision challenging for carers. This includes use of local applications, internet browsing, communication and game play. Carers with responsibility for supervision and mentoring of users using such technology therefore need to know and evaluate what activities the user is engaged in, regardless of which device is being used.

Some monitoring products exist to log or transmit internet browsing history from a specific computer, such as URLs and/or screenshots. However, prior software products generally do not account for the fact that many users use multiple devices and sometimes such users regularly switch their focus from one device to another. To monitor all devices of a user using prior techniques, the supervisor would have to have multiple products installed on the user devices and would need to have a way of monitoring multiple display screens, one for each such user device.

It would be desirable to address or ameliorate one or more shortcomings or disadvantages associated with prior monitoring techniques, or at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

Some embodiments relate to a system for monitoring user activity on a plurality of networked devices, the system comprising:
a central monitoring device comprising a monitor display and capable of wireless communication over a network;
a plurality of personal computing devices, each comprising a display and being capable of communication with the central monitoring device over the network, each personal computing device being associated with a supervised user and comprising a software agent executing on the computing device when the personal computing device is powered on;
wherein each software agent is configured:
   to monitor user activity of the personal computing device on which it is executing,
   to transmit user activity data to the central monitoring device when the personal computing device is in use, and
   to transmit to the central monitoring device display images from the display of the personal computing device;
wherein display images received by the central monitoring device from one or more of the personal computing devices are displayed on the monitoring display.

The plurality of personal computing devices comprises at least two personal computing devices associated with a same supervised user, and wherein the central monitoring device is configured to determine from user activity data received from each of the at least two personal computing devices which one of the at least two personal computing devices is most actively used. Each software agent may be configured to transmit the display images to the central monitoring device in response to a request for the display images and the central monitoring device may be configured to transmit the request for the display images to the software agent of the one of the personal computing devices that is determined to be most actively used. The central monitoring device may be configured to display on the monitor display the display images received from the one personal computing device associated with the same supervised user determined to be most actively used.

Each software agent and the central monitoring device may be configured to communicate using virtual network computing (VNC) or a similar data transfer protocol.

Each software agent may be configured to compress the display images prior to transmitting them to the central monitoring device. The central monitoring device may be configured to monitor system performance and is configured to instruct a software agent that is transmitting display images to perform lossy compression and optionally automatic image scaling when the central monitoring device determines that system performance is degraded or is at risk of becoming degraded.

The central monitoring device and/or each software agent may be configured to operate in one of a local mode or a remote mode, depending on whether the central monitoring device and the respective software agent are detected to be both connected to a home network. In the local mode, a respective software agent may transmit the display images as a streaming display to the central monitoring device and in the remote mode, the central monitoring device may receive a periodic update of display information indicative of user activity occurring at the personal computing device on which the respective software agent is executing.

Each software agent may be configured to classify monitored user activity as play activity, learning activity or another activity. The software agent may separately time the activities in order to evaluate and give the user and supervisor reports of activities as a form of feedback for behaviour modification.

The central monitoring device may be configured to display a descriptor associated with received display images based on received user activity data, and the descriptor may include one of: an activity descriptor, a game console name, a game title, a file title, an application title, a web page title, a uniform resource indicator, a file path name and a file name. The descriptor may be displayed or displayable in a banner across a part of a view port through which the received display images are displayed on the monitor display.

The central monitoring device may be configured to display a supervised user name in relation to a view port through which images received from a personal computing device associated with a respective supervised user are to be displayed if received.

The central monitoring device may be configured to operate in a local mode when the central monitoring device is within a home local area network. The system may further comprise a game console in communication with the home local area network, and the central monitoring device may be configured in the local mode to monitor communications from the game console over the home local area network and to determine from the monitored communications whether the game console is in active use.

The system may further comprise a server. The server may be in communication with one or more of the central monitoring device and the plurality of personal computing devices over the network. The server may be configured to act as a communication gateway between the central monitoring device and one or more of the personal computing devices when the central monitoring device or the one or more personal computing devices are outside of a home local area network. The server may also be configured to act as the central monitoring device and be accessible by the supervisor user via a browser application executing on a client computing device that is in communication with the server.

The central monitoring device and each software agent may be configured to enable establishment of a voice call between the central monitoring agent and the personal computing device on which a respective software agent is executing. When the central monitoring device and the personal computing device on which a respective software agent is executing are both in a same local area network, the central monitoring device and respective software agent may be configured to establish the voice call by establishing a voice-over-internet protocol connection. Voice calls initiated from the central monitoring device to a supervised user may be configured to be automatically routed by the central monitoring device to the one of multiple personal computing devices associated with the supervised user determined by the central monitoring device to be most actively used by the supervised user. In some embodiments, the central monitoring device and each software agent are configured to enable transmission of text messages via a shared local network between the central monitoring device and the personal computing device that is determined to be most actively used.

The personal computing devices may comprise personal computing devices associated with different supervised users and the monitor display may comprise a view port associated with each different supervised user, each view port to display received display images from a personal computing device associated with a respective supervised user.

The plurality of personal computing devices may comprise at least two personal computing devices associated with a same supervised user, and the central monitoring device may be configured to determine from user activity data received from each of the at least two personal computing devices which one of the at least two personal computing devices is most actively used and to switch or not switch between display images of the at least two personal computing devices so that images displayed in the monitor display are images received from the personal computing device determined to be most actively used. The central monitoring device may apply a short time delay to switching between display images of the at least two personal computing devices.

Some embodiments relate to a monitoring device for monitoring user activity on a plurality of networked devices, the monitoring device comprising:
a wireless communication sub-system for local area network communication;
an image display;
at least one processor; and
memory storing program code executable by the at least one processor to cause the monitoring device to:
   receive user activity data from a software agent executing on each of a plurality of personal computing devices in local area network communication with the monitoring device, the user activity data being indicative of use of the respective personal computing device by a supervised user,
   receive from at least one of the personal computing devices display images from a display of the at least one personal computing device, and
   display in at least a part of the image display the display images received from the at least one personal computing device.

The plurality of personal computing devices may comprise at least two personal computing devices associated with a same supervised user, and the monitoring device may be configured to determine from user activity data received from each of the at least two personal computing devices which one of the at least two personal computing devices is most actively used. The code may be executable to cause the monitoring device to enable transmission of text messages via a shared local network between the monitoring device and the one personal computing device that is determined to be most actively used.

The monitoring device may receive the display images in response to a request for the display images and the monitoring device may be configured to transmit the request for the display images to the software agent of the one of the personal computing devices that is determined to be most actively used. The monitoring device may be configured to display on the monitor display the display images received from the one personal computing device associated with the same supervised user determined to be most actively used. The monitoring device may be configured to communicate with each software agent using virtual network computing (VNC) or a similar data transfer protocol.

The monitoring device may receive compressed display images from each personal computing device and is configured to decompress the compressed display images. The central monitoring device may be configured to monitor system performance across the plurality of networked devices and may be configured to instruct a software agent that is transmitting display images to perform lossy compression and optionally automatically scale transmitted display images when the central monitoring device determines that system performance is degraded or is at risk of becoming degraded.

The monitoring device may be configured to operate in one of a local mode or a remote mode in relation to communication with each personal computing device, depending on whether the monitoring device and the respective software agent of a personal computing device are detected to be both connected to a home network. In the local mode, the monitoring device may receive the display images from at least one of the personal computing devices as a streaming display, and in the remote mode, the central monitoring device may receive a periodic update of display information indicative of user activity occurring at the personal computing device on which the respective software agent is executing.

The monitoring device may be configured to display a descriptor associated with received display images based on received user activity data. The descriptor may include one of: an activity descriptor, a game console name, a game title, a file title, an application title, a web page title, a uniform resource indicator, a file path name and a file name. The descriptor may be displayed or displayable in a banner across a part of a view port through which the received display images are displayed on the monitor display.

The monitoring device may be configured to display a supervised user name in relation to a view port through which images received from a personal computing device associated with a respective supervised user are to be displayed if received.

The monitoring device may be configured to operate in a local mode when the monitoring device is within a home local area network, and to detect whether a game console is in communication with the home local area network. The monitoring device may be configured in the local mode to monitor communications from the game console over the home local area network and to determine from the monitored communications whether the game console is in active use.

The monitoring device may be in communication with a remote server over the network, the server being configured to act as a communication gateway between the monitoring device and one or more of the personal computing devices when the central monitoring device or the one or more personal computing devices are outside of a home local area network. The monitoring device may be configured to enable establishment of a voice call between the monitoring agent and at least one of the personal computing devices on which a respective software agent is executing.

The personal computing devices may comprise personal computing devices associated with different supervised users and the monitor display may comprise a view port associated with each different supervised user, each view port to display received display images from a personal computing device associated with a respective supervised user.

The plurality of personal computing devices may comprise at least two personal computing devices associated with a same supervised user. The monitoring device may be configured to determine from user activity data received from each of the at least two personal computing devices which one of the at least two personal computing devices is most actively used and to switch or not switch between display images of the at least two personal computing devices so that images displayed on the monitor display are images received from the personal computing device determined to be most actively used. The monitoring device may apply a short time delay to switching between display images of the at least two personal computing devices.

Some embodiments relate to a personal computing device comprising:
a wireless communication sub-system for local area network communication;
an image display;
at least one processor; and
memory storing program code executable by the at least one processor to implement a software agent program, the software agent program configured to:
   monitor user activity in relation to the personal computing device,
   transmit to a monitoring device display images from the image display when monitored user activity indicates active use of the personal computing device by a supervised user, and
   display in at least a part of the image display a graphical indication that user activity on the personal computing device is being monitored by the software agent program and the monitoring device.

Some embodiments relate to a method of user activity monitoring by a monitoring device having an image display, the method comprising:
receiving user activity data from a software agent executing on each of a plurality of personal computing devices in local area network communication with the monitoring device, the user activity data being indicative of use of the respective personal computing device by a supervised user;
receiving from at least one of the personal computing devices display images from a display of the at least one personal computing device; and
displaying in at least a part of the image display the display images received from the at least one personal computing device;
wherein the plurality of personal computing devices comprises at least two personal computing devices associated with a same supervised user, and wherein the monitoring device determines from user activity data received from each of the at least two personal computing devices which one of the at least two personal computing devices is most actively used, and wherein the displaying comprises displaying on the image display the display images received from the one personal computing device associated with the same supervised user determined to be most actively used.

Some embodiments relate to a method of establishing voice communication between an originating device and one of a plurality of personal computing devices, the method comprising:
receiving at the originating device user activity data from a software agent executing on each of the plurality of personal computing devices, the user activity data being indicative of use of the respective personal computing device by a supervised user, wherein the plurality of personal computing devices comprises at least two personal computing devices associated with a same supervised user;
receiving input at the originating device to establish voice communication between the originating device and the supervised user;
determining, by the originating device, which one of the at least two personal computing devices is most actively used based on user activity data received from each of the at least two personal computing devices; and
establishing voice communication between the originating device and the one personal computing device associated with the same supervised user determined to be most actively used.

Some embodiments relate to a method of establishing voice communication between an originating device and one of a plurality of personal computing devices, wherein the plurality of personal computing devices comprises at least two personal computing devices associated with a same supervised user, the method comprising:
receiving input at the originating device to establish voice communication between the originating device and the supervised user;
determining, by the originating device, which one of the at least two personal computing devices is most actively used based on user activity data obtained in relation to each of the at least two personal computing devices; and
establishing voice communication between the originating device and the one personal computing device associated with the same supervised user determined to be most actively used.

Some embodiments relate to computer-readable storage storing executable program code to implement methods and/or systems described herein.

Some embodiments relate to methods of monitoring user activity as broadly described herein. Some embodiments relate to methods of dynamically switching a monitoring device or a personal computing device between a local mode and a remote mode as broadly described herein.

### BRIEF DESCRIPTION OF THE DRAWINGS

Embodiments are described in further detail below, by way of example, with reference to the accompanying drawings, in which:

FIG. 1 is a block diagram of a system for monitoring user activity on a plurality of networked computing devices;

FIG. 2 is a block diagram showing further details of some of the plurality of networked computing devices;

FIG. 3 is a block diagram showing further details of a monitoring device for use in monitoring user activity on other networked computing devices within the system;

FIG. 4 is a flowchart of a method of monitoring a most actively used device from among multiple computing devices used by or associated with the same user;

FIG. 5 is a flow chart of a method of dynamically switching a user device between a local mode in which it is monitored through a local area network, and a remote mode, in which it is monitored by a remote server;

FIG. 6 is a flowchart of a method of dynamically switching a monitoring device between a local mode and a remote mode;

FIG. 7 is an example screen display of the monitoring device showing multiple view ports for multiple monitored users;

FIG. 8 is an example display of the monitoring device showing the multiple view ports and illustrating view port displays for inactive users;

FIG. 9A is an example screen portion displayed on a user device, illustrating an option window including an activity type indicator indicating a play activity is currently detected;

FIG. 9B is a display of part of the screen of the user device similar to FIG. 9a, but showing an indication that the detected user activity type is a learning activity;

FIG. 10 is a close up display of part of an option window in each view port of the monitoring device;

FIG. 11A is an example user computing device display, including a monitoring status indicator to indicate to the user that the computing device display is not currently being monitored; and

FIG. 11B is a partial display including an indication to the user that the display of the computing device is being remotely viewed.

### DETAILED DESCRIPTION

Described embodiments generally relate to methods and systems configured for remote automatic selection and monitoring of a most actively used computer device from among a plurality of computer devices accessible to and logged into by a specific user. Such methods and systems also involve the display of the user's screen on a dedicated monitoring display device. Where multiple users are monitored, the displays of the user devices that are most actively used are reproduced on the monitoring device display in dedicated view ports for the users being monitored.

Embodiments generally involve the use of software agents installed and executing on each user device that is turned on. Such software agents assist in allowing the monitoring device to determine which of the user devices is most actively used by a particular user.

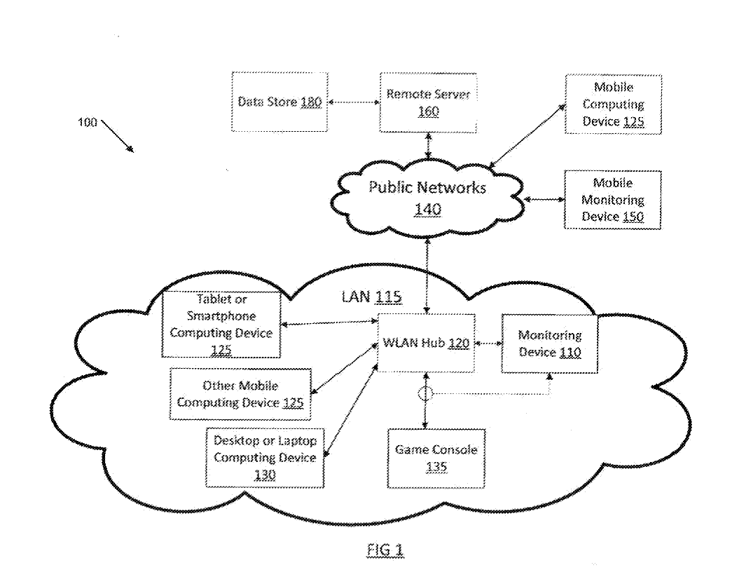

Referring now to FIG. 1, there is shown a system 100 for monitoring user activity. The system 100 comprises a monitoring device 110, one or more mobile computing devices 125, which may include tablet computing devices, smartphones or other mobile computing devices, optionally or alternatively one or more laptop or desktop computing devices 130 and optionally also one or more game consoles 135, all of which are in wired or wireless communication with a wireless local area network (WLAN) hub 120, which performs wireless router functions and acts as a modem. In a family household, there may be two, three or more devices for each member of the household, so there may be five to ten or more computing devices 125, 130 in the household.

Embodiments of system 100 are configured to accommodate the monitoring device 110, the WLAN hub 120, and a number of computing devices, such as mobile computing devices 125, desktop or laptop computing devices 130 and game consoles 135 within a local area network (LAN) 115. Each of those computing devices may communicate with one or more public networks 140, for example including the Internet and other public communication infrastructure, via the WLAN hub 120. The WLAN hub 120 may be any suitable local wireless modem or similar device that has a wired or possibly wireless connection to the public networks 140 and has the capability of wirelessly networking multiple computing devices within a local area in a known manner.

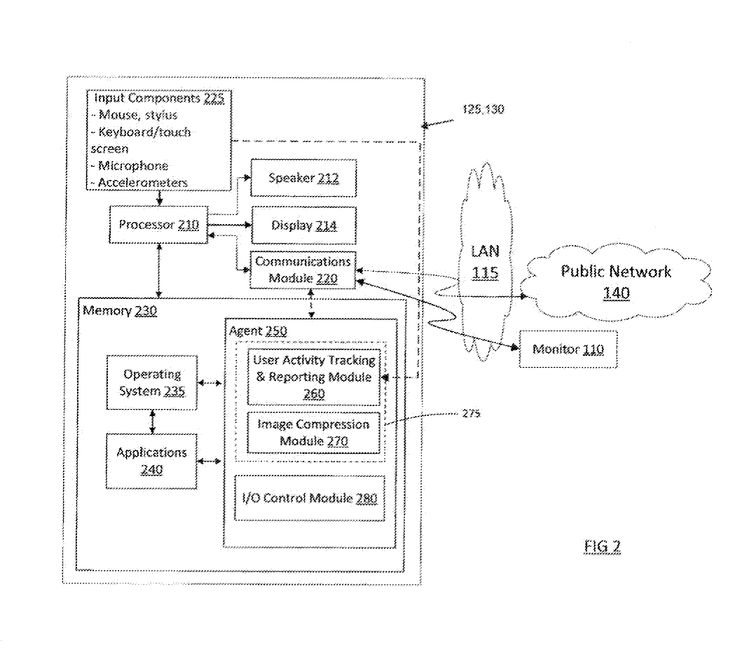

System 100 further comprises a dedicated remote (virtual) server 160 to provide software updates to monitoring device 110 and software agents 250 (FIG. 2) installed in the computing devices 125, 130. Remote server 160 also serves as a communication gateway, by either passing information between devices or resolving their IP addresses and establishing a peer-to-peer connection, for any computing device 125 or mobile monitoring device 150 that is outside the LAN 115 to communicate with computing devices within the LAN 115 or computing devices 125 that are (temporarily) only accessible via external means, such as the public networks 140. System 100 also comprises a data store 180 accessible to server 160 to store user account information and optionally also executable program code to enable the server 160 to perform the software updating and communications gateway functions described herein. Such executable program code may alternatively be stored in a persistent memory of server 160 separate to data store 180.

Server 160 is preferably a virtual server, with distributed functions. Server 160 can be colloquially referred to as being “in the cloud”, meaning that it may comprise a set of virtualised servers configured to adapt dynamically to demand and is effectively provided as an on-demand computing service. This arrangement for server 160 advantageously allows for ease of scalability, network throughput, reliability and cost-control.

Referring also to FIG. 2, a generalised description of the mobile computing device 125 and desktop or laptop computing device 130 is provided. Each such computing device 125, 130 has a processor 210 and a memory 230. The computing device 125, 130 also has a speaker 212, display 214, communications module 220, one or more input components 225. The input components 225 may include, for example, a mouse, stylus, keyboard, touchscreen, track-pad, or other manually operable user selection/input device, a microphone, optionally one or more accelerometers for laptop or hand held computing devices and optionally other devices or components that allow user input and/or environmental input. The communications module 220 is configured to allow the computing device 125, 130 to communicate with other devices in the LAN 115 or possibly through the public networks 140 if the LAN 115 is not available. The communications module 220 controls one or more antennas for wireless communication, although some embodiments may also be configured for wired communication.

Memory 230 comprises suitable random access memory (RAM), a non-volatile memory, such as read-only memory (ROM), flash memory and/or other forms of persistent storage. Memory 230 comprises executable program code for implementing an operating system 235 of the computing device 122, 130, as well as software applications 240. Such software applications 240 may include a browser application, one or more games, word processing software, one or more educational programs or interfaces or other applications. Memory 230 further comprises a software agent 250 that interacts with the operating system 235 and the software applications 240 to monitor and track the user activity on the computing device 125, 130. The software agent 250 comprises a user activity tracking and reporting module 260, an image compression module 270 and an input/output (I/O) control module 280.

The user activity tracking and reporting module 260 monitors one or more types of user actions on the computing device 125, 130, including keyboard keystrokes, mouse movements and clicks, and touchscreen touches. Depending on the specific user interface hardware employed by the computing device 125, 130, the specific user actions monitored by the user activity tracking and reporting module 260 may vary. Further, if accelerometers are included in the computing device 125, 130, the user activity tracking and reporting module 260 may monitor their specific vibration patterns or movement patterns that may indicate active use of the device. In another example, if the user activity tracking and reporting module 260 determines that a microphone input is detected, a speaker output is detected and the video camera input is detected, then this is indicative of a video call engaged in by the user.

According to some embodiments, the user activity tracking and reporting module 260 may effectively listen in on the signals provided by the input components 225 to the processor 210 in order to monitor the user actions and may then transmit status update signals or messages to the monitoring device 110 to indicate the detected activity (or lack thereof). Further, the user activity tracking and reporting module 260 is configured to detect when a particular user logs on for use of the device 125, 130.

In some embodiments, the monitoring device 110 and the personal computing device 125, 130 (to which a supervised user is logged on) may be the same physical device. In this case, the monitoring device 110 functions as a virtual (software) device distinct from the personal computing device on which it is executing. Similarly, the software agent 250 executing on that same personal computing device monitors user activity on that personal computing device as if it were a physically distinct device from the monitoring device 110. In this case, the virtually separated devices communicate via internal port connections as if they were on the network 115.

In some alternative embodiments, the user activity tracking and reporting module 260 may have a less pro-active role in notifying the monitoring device 110 of user activity and since the monitoring device 110 may use virtual network computing (VNC) features already built in to a communications protocol, such as the remote frame buffer (RFB) protocol, to determine or infer the level of user activity occurring at the computing device 125, 130 while the computing device 125, 130 sends display images to the monitoring device using the cooperative VNC features. For example, for image display updates transmitted from the computing device 125, 130 to the monitoring device 110, the amount of changes in the display images can be detected directly from the RFB protocol. Additionally, user interaction with the computing device 125, 130, for example through keyboard, mouse or touch-screen, can be detected using the RFB protocol, which indicates a level of user activity. The RFB protocol is a “pull protocol” controlled by the client device in a client-server based VNC arrangement, which in this case is the monitor device 110. In such an arrangement, each of the computing devices 125, 130 acts as a VNC server device when transmitting display images to the monitoring device 110.

If the user activity tracking and reporting module 260 determines that the computing device 125, 130 is not in use, then it may cause the transmission of images from display 214 to be blocked from being sent to the monitoring device 110. However, if the user wants to use the computing device 125, 130 without any interaction, such as to watch a movie for a period of time, the user has the option to declare the intent to actively use the device for the chosen activity for a certain period of time. However, this is cancelled automatically if the activity changes or may be cancelled at any time by the user (by making an appropriate user selection or an activity cancellation option).

The user activity tracking and reporting module 260 monitors the nature of the activity the user is actively engaged in, including the specific software application currently used, any data object being manipulated, the URL of any webpage being viewed, and the images displayed on display 214.

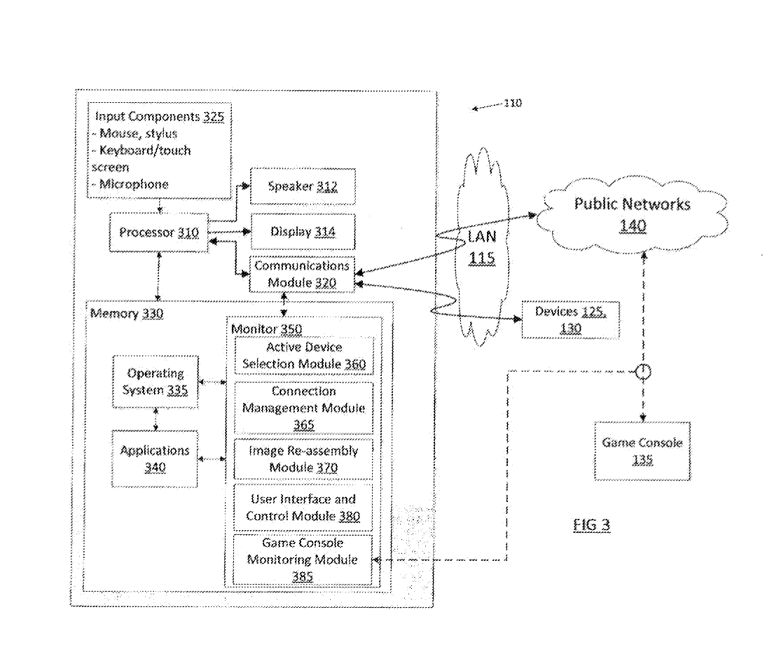

When a software agent 250 is transmitting display images of part or all of display 214 to the monitoring device 110, the image compression module 270 may compress the image data prior to transmitting it. The image compression module 270 may use a compression method according to H.264/MPEG-4 AVC, for example, to compress the parts of the imagery on display 214 to be sent before providing the compressed image data to the communications module 220 to send to the monitoring device 110. H.264 is a streaming protocol that normally flows over a RTP/UDP channel, with a RTCP control channel optionally providing flow control. Where the connection management module 365 (FIG. 3) of the monitoring device 110 detects that communication speed (or another measure of system performance) within the LAN 115 is becoming degraded or is at immediate risk of becoming degraded, the connection management module 365 may instruct the image compression module 270 (via a control channel) to perform lossy compression in order to reduce the data transfer load on the WLAN hub 120 and/or system 100. Such lossy compression may be dynamically altered depending on the monitored system performance, so that as the system performance improves or degrades, the connection management module 365 instructs the image compression module 270 that the degree of compression loss to be applied to the transmitted display images is to be reduced or increased, respectively.

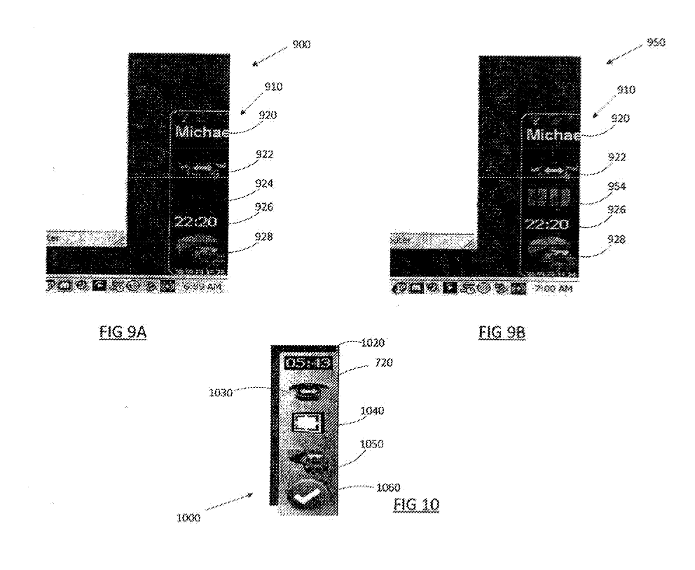

In order to minimise system resource use (including the use of processor 210 and processor 310 and network traffic among devices in LAN 115), the image reassembly module 370 of the monitoring device 110 records in storage the display size and resolution set by the supervising user (using configuration selection 1050 in FIG. 10 and by manually resizing the viewport boundaries 740, such as by clicking and dragging them). The image reassembly module 370 determines the smallest resolution available from the respective computing device 125, 130 that just adequately fills the display area selected by the user for the viewport (e.g. 705, 710 or 715). The image reassembly module 370 then transmits a command to the respective image compression module 270 of the computing device transmitting images for that viewport to transmit the images (or only those parts of images that have changed) at the determined smallest resolution.

For media streaming protocols, a roughly typical amount of data for a busy screen content may be: 25 frames/second and 8500 kilobytes/second at 800×900 screen resolution or 25 f/s and 11840 kb/s at 1490×900 screen resolution for MPEG streaming; 20 f/s and 24 Mb/s at 800×900 screen resolution for VNC streaming with hextile encoding with 24 bit colour; and 25 f/s and 11 Mb/s full quality for TeamViewer. Thus, a streaming protocol other than VNC may be used. Whichever image display streaming protocol is used, it is desirable that it allow for image compression, in particular dynamically controllable lossy compression.

In some embodiments, the functions of the user activity tracking and reporting module and the image compression module 270 may be combined into a single functional module 275 that acts as a monitoring and reporting module. Such a monitoring and reporting module 275 may be employed where the user activity tracking functions are wrapped up in the image compression and/or transmission functions of the agent 250.

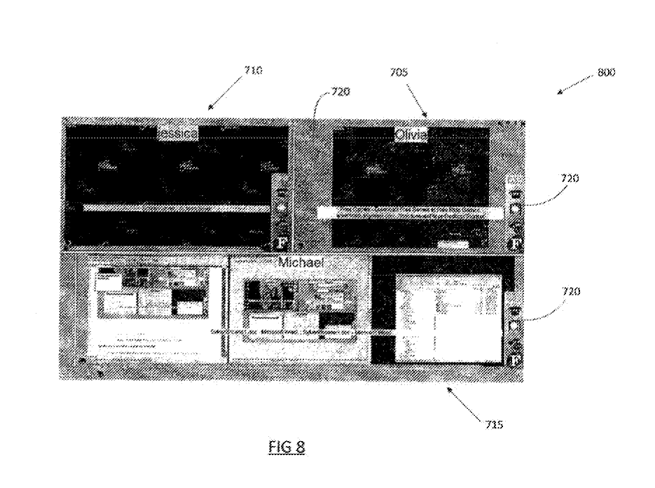

The input/output (I/O) control module 280 handles user interactions with the software agent 250, including options described below in relation to FIGS. 9A, 9B and FIG. 10 and shown in user option window 910. The I/O control module 280 allows, for example, a voice call to be made from the computing device 125, 130 to the monitoring device 110 (as facilitated by user interface and control module 380 shown in FIG. 3) in order to receive supervision. This voice call may be conducted over a voice-over-internet protocol (VoIP) connection, for example and thus the I/O control module 280 may use suitable VoIP software to conduct such a call.

In some embodiments, VoIP may be used for such verbal communication between supervisor and supervisee, but in other embodiments, other protocols may be used. For example, where echo or feedback makes communication difficult or problematic, or by user configuration, instead of a voice channel being opened between a particular computing device 125, 130 and the monitoring device 110, a click-to-talk (walkie-talkie-style) series of discrete one-way voice messages may be transmitted between those devices using suitable encoding software. The type of voice communication (VoIP or walkie-talkie) may be user configured by a configuration menu (not shown) displayed in response to selection of configuration selection option 1050 (FIG. 10) displayed on the monitor display 314. Alternatively, the user interface and control module 380 may be configured to automatically select the type of voice communication to be used in response to detected echo or feedback at the microphones of the computing device 125, 130 and/or the monitoring device 110.

Advantageously, voice calls initiated from the monitoring device 110 to a supervised user may be configured to be routed through to the one of a multitude of personal computing devices 125, 130 associated with the supervised user that is determined by the monitoring device to be most actively used by the supervised user.

Generally, the selective voice communication between the monitoring device 110 and one of the personal computing devices 125, 130 is more a form of a person to person communication, rather than being about device to device communication (even though that occurs). This style of communication may be useful in telecommunications generally as people each get more personal computing and telecommunication devices. For example, if a particular user has a multitude of computer/telecommunication devices 125, then previously it would have been necessary to call each of the user's phone numbers one by one until the call is answered (if at all). However, by having the monitoring device originate a call to the one personal computing device 125 determined to be most actively used, a call from the monitoring device 110 to that personal computing device would have the greatest chance of reaching the user. This can be done with the cooperation of the software agent 250 on that device 125, which reports user activity to the monitoring device directly or via the server 160. Alternatively, user activity may be determined by the monitoring device more passively, with the aid of information stored on a data store accessible to a server of the user's mobile telephony service provider, indicating which device the user used last. In this more passive service provider model, connecting the voice call would be a form of automatic call forwarding by the telephony service provider to whichever device belonging (or registered) to that user the mobile telephony service provider can best determine was last used.

The configuration of each agent 250 may be somewhat different, depending on the computing device that it is to be installed on. For example, desktop and laptop computing devices 130 commonly use similar operating systems, so the configuration of the software agent 250 for such devices will be the same for the same operating systems, except that the laptop screens are generally smaller and the user interface adapts to the screen resolution dynamically. However, the configuration for the software agent 250 for the smart phone and tablet device embodiments (mobile computing device 125) will differ depending on the underlying operating system employed by the device and will differ from the software agents 250 installed on desktop and laptop computing devices 130.

Example versions of the software agent 250 may include the following features for the following operating systems:

Windows™: full featured agent with intercom, remote screen, activity capture of applications and internet access, supervised user's (simplified child-friendly) user interface to the software.

MacOS X: full featured agent with the same feature set as Windows.

Android™: the software agent 250 may comprise a special-purpose android web browser application that can track and report URL activity for a child/supervised user to the monitoring device 110 and receive back cumulative play time by that child/supervised user, a user interface for the child to know how much play time they have left, prevent use of the device when out of play time, and also logout and configure which family viewer (monitoring device 110) the browser application should be linked with. An intercom application may also be included but may not be provided as part of the same android browser application. Embodiments may additional have the ability to track and monitor activities of other applications executing on the Android devices, including remote screen monitoring (on devices that support this capability).

iOS: the software agent 250 may comprise a special-purpose iOS web browser application that can track and report URL activity for a child/supervised user to the monitoring device 110 and receive back cumulative play time by that child/supervised user, a user interface for the child to know how much play time they have left, prevent use of the device when out of play time, and also logout and configure which family viewer (monitoring device 110) the browser application should be linked with. Some embodiments of this version of the software agent 250 include an intercom application that allows the child to call the parent and vice-versa but other embodiments may use a separate application for that purpose. At present, monitoring of other applications and remote screen capture on iOS devices is disallowed by Apple and so this version of the software agent 250 will not feature that implementation unless Apple opens up their application program interface (API) to allow it.

In some embodiments, the software agent 250 may have less than all of the features described herein, in order for it to be compatible with the mobile computing device 125 on which it is installed. Software agents 250 of various different configurations may be comprised in the same system 100 where the system comprises multiple different computing devices 125, 130 of different types.

Referring also to FIG. 3, the monitoring device 110 is shown and described in further detail. The monitoring device 110 has a processor 310 and a memory 330. The processor 310 may include a graphics card or other specialised image processing unit. The monitoring device 110 also has a speaker 312, display 314, communications module 320 and one or more input components 325. The input components 325 may include, for example, a mouse, stylus, keyboard, touchscreen, track-pad, or other manually operable user selection/input device, a microphone, and optionally other devices or components that allow user input and/or environmental input. The communications module 320 is configured to allow monitoring device 110 to communicate with other devices in the LAN 115 or possibly through the public networks 140 if the LAN 115 is not available. The communications module 320 controls one or more antennas (not shown) for wireless communication, although some embodiments may also be configured for wired communication.

Memory 330 comprises suitable random access memory (RAM), non-volatile memory, such as read-only memory (ROM), flash memory and/or other forms of persistent storage. Memory 330 comprises executable program code for implementing an operating system 335 of monitoring device 110, as well as software applications 340. Such software applications 340 may include a browser application, one or more games, word processing software, one or more educational programs or interfaces or other applications. Memory 330 further comprises a monitoring component 350 that interacts with the operating system 335 and the software applications 340 to monitor and track the user activity on the computing device 125, 130. The monitoring component 350 comprises an active device selection module 360, a connection management module 365, an image re-assembly module 370 and a user interface and control module 380.

The monitoring device 110 may comprise a specialised monitoring device, such as a special purpose tablet computer, or a desktop or laptop computer with the monitoring component installed and executing thereon.

The active device selection module 360 selects the one computing device that is most actively used based on the status signals and/or messages received from the computing devices 125, 130 in the LAN 115. If multiple computing devices 125, 130 indicate active use, then the active device selection module 360 applies a hierarchy of use indicators to decide which of those computing devices is most actively used. Such indicators include, for example, user activity type (as reported by the agent 250 on that computing device), computing device type and computing device use history.

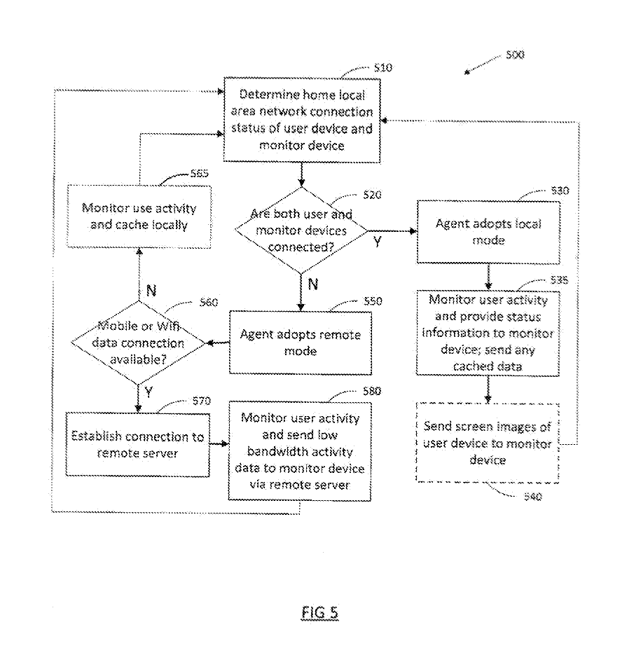

The connection management module 365 allows the monitor 350 to communicate with each software agent 250 via the communications module 320 (and corresponding communications module 220 in client devices 125, 130) via LAN 115 and/or public network 140. Each of the software agents 250 and the monitor 350 regularly watch for the presence of the other within the home network. Such tracking of the software agents 250 by the monitor 350 is performed by the connection management module 365 and on the agents side is performed by the user activity tracking and reporting module 260. The connection management module 365 thus tracks the presence or absence of each registered personal computing device 125, 135 within the LAN 115 and, depending on whether a given personal computing device 125, 130 is present or absent from the LAN 115, the connection management module 365 will treat it as being either local or remote, respectively. If the monitoring device 110 is in the LAN 115 and a particular personal computing device 125, 130 is determined to also be present, then both such devices operate in a local mode, as described in further detail below with respect to FIGS. 5 and 6. Otherwise, if either or both of the monitoring device 110 and a personal computing device 125, 130 are outside of the LAN 115, then each such device that is outside the LAN adopts a remote communication mode, in which streaming of display images from the personal computing device 125, 130 to the monitoring device 110 may not be performed (for example, due to cost and/or bandwidth constraints).

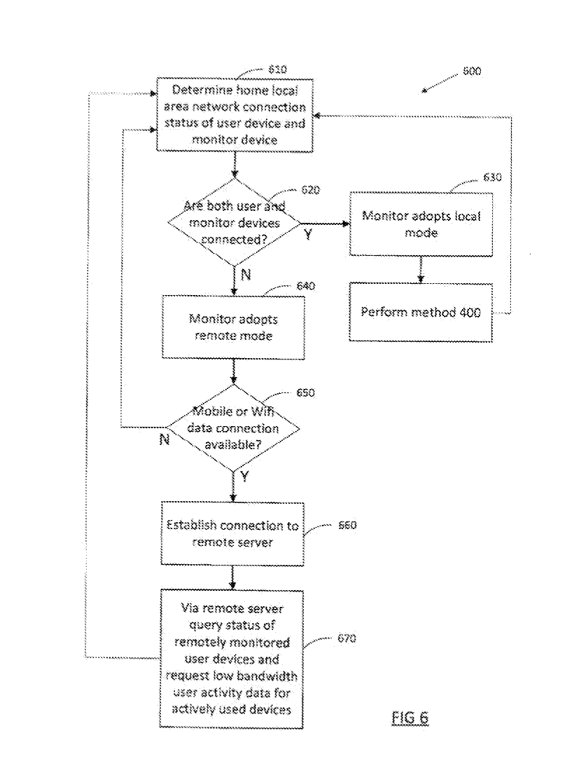

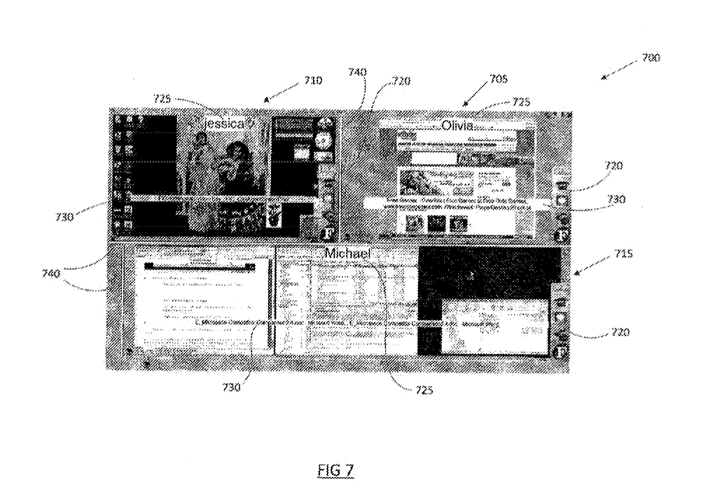

Image reassembly module 370 within monitor 350 is responsible for processing compressed display images received from each personal computing device 125, 130 via communications module 320 and decompressing and reassembling such display images for display to the supervising user via display 314, as depicted in FIGS. 7 and 8, for example. The display images processed and reassembled by image reassembly module 370 may include a VNC or MPEG data stream that may be initially decoded using a graphics card or specialised processor comprised in the at least one processor 310. The image reassembly module 370 communicates with the user interface and control module 380 to determine the required screen scaling to apply to the images to be displayed in one of the viewports (FIG. 7) above the display 314 and the image reassembly module 370 either communicates this screen scaling to the relevant software agent 250 for suitable scaling/compression on the agent side or such scaling can simply be applied to the received and decompressed image data by imagery assembly module 370. Since each viewport of display 314 may be dynamically scaleable by the supervising user, the image reassembly module 370 may need to recompute the required screen scaling in order to suitably display received images within that viewport. The image reassembly module 370 requests that the image scaling be performed at the software agent 250 in order to advantageously maintain a lower communication bandwidth consumption across the system 100.

User interface and control module 380 provides the interface between the monitoring functions of the monitoring device 110 and the supervising user. The user interface and control module 380 provides an interactive control bar or options menu 1000 (FIG. 10) that allows the supervising user to configure the viewports, configure the level of monitoring and supervision of a particular supervised user and initiate speech interaction with a supervised user via a voice call or voice messages transmitted between the monitoring device 110 and a selected supervised user (via whichever computing device 125, 130 is determined to be most actively used). User interface and control module 380 also controls configuration of data parameters affecting the functioning of the software agent 250 and configuration of compression and display functions performed by the image reassembly module 370. The user interface and control module 380 controls the display of information to the supervising user regarding the user activity monitored by the agents 250 and received by the active device selection module 360.

Advantageously, the monitoring device 110 applies a time hysteresis (delay) of several seconds to switching the display (between user computing devices) in response to input signals or computational determinations indicative of activity on the computing devices 125, 130. This hysteresis causes the monitoring device 110 to briefly delay switching the images displayed in a view port of display 314 once a new device is determined to be the most actively used computing device. This delay is to avoid excessively frequent switching between different computing devices 125, 130 due to noise of isolated events on unused or less used computing devices.

In some embodiments, the user interface and control module 380 may cooperate with the connection management module 365 and the active device selection module 360 to enable two-way transmission of text messages between the monitoring device 110 and one of a plurality of the computing devices 125, 130 that is determined by the active device selection module 360 to be most actively used. Such communication can occur within the home network (LAN 115) via the WLAN hub 120, rather than via external messaging service providers, such as mobile phone service providers. The user interface and control module 380 may facilitate the generation of a suitable messaging display interface for use by the respective users of the monitoring device 110 and the computing device 125, 130 that is most actively used. The display interface may include messaging bubbles and a scrolling history of messages, as is in current commercial use in some computing devices.

The text messages may be sent via a communication protocol already established between the monitoring device 110 and the computing device 125, 130 via a shared local network, such as a home network for those devices, like LAN 115, or another shared local network, such a public WiFi network. If the monitoring device 110 and the computing device 125, 130 are not in the same local network, then such messages may be routed via the server 160.

This selective routing of text messages to one of a plurality of a user's computing devices that is determined to be most actively used (and not to the other ones of the user's devices), has the advantage that the logged on user receives the text message on whichever device they are using, and only on that device, without having to do any specific actions, such as launching applications or setting flags indicating active use of the device.

The monitoring device 110 may additionally comprise a game console monitoring module 385 to monitor use of a game console 135, such as an XBOX™ or Playstation™, for example. When in active use, such game consoles may connect to an external network, such as a public network 140, via the WLAN hub 120 and, in doing so, regularly transmit messages to the WLAN hub 120 that can be listened to by the game console monitoring module 385 of the monitoring device 110. By monitoring certain messages sent from the game console 135, the monitoring device 110 can also determine whether the game console is in active use. This type of passive monitoring of the game console is used because it is generally not permitted to install a software agent 250 on most currently available game consoles. However, in future, where game consoles become more integrated with personal computing devices, installation of a software agent 250 on the game console may become possible, in which case it would be preferable to have such a software agent 250 installed and executing on the game console to allow more active supervision of user activity on the game console 135.

In order to passively monitor the active use of the game console 135, the game console monitoring module 385 cooperates with the communications module 320 to first listen in to the broadcast traffic from the game console (e.g. broadcast via user datagram protocol (UDP)) that occurs at logon and periodically thereafter and that identifies the IP address on the network. UDP messages and other messages from the game consoles may include a unique identifier and manufacturer code, which, once observed, allows the game console monitoring module 385 to identify the game console 135. Once the game console IP address on the network is discovered by the game console monitoring module 385, then the game console monitoring module 385 regularly queries/pings certain ports on the game console 135 using the communications module 320 and determines from the response whether the game console 135 is in active use or not. The game console monitoring module 385 can also determine whether the game console 135 is connected to the Internet. With this method, the monitoring device 110 cannot intercept chat sessions or receive images from the display of the game console 135.

In some embodiments, active use (when detected by the game console monitoring module 385) of the game console 135 may be indicated in a dedicated viewport of the monitor display 314. This may be indicated on monitor display 314 by an emphasised or animated game console logo or icon, optionally together with a banner 730 indicating active use of the game console 135, for example. The game console logo or icon may be displayed in the viewport even when it is not detected to be in active use, and in such a case, the logo or icon may be de-emphasised or unanimated. There is generally no opportunity for the user to login to the game console 135, so the user's use of the game console 135 must be recorded via the user interface and control module 380 of the monitoring device 110 if such activity is to be monitored by the game console monitoring module 385. The time recording of the user's active use of the game console 135 may be effected by user input from the supervising (or supervised) user using a device selection function displayed on monitor display 314 in relation to a viewport 705, 710, 715 dedicated to a particular user, for example.

Once the active use of the game console 135 is no longer detected by the game console monitoring module 385, that module sends a message to that effect to the user interface and control module 380. The user interface and control module 380 calculates the total time of active use of the game console by the recorded user (in addition to other play activities by the same supervised user on other computing devices 125, 130) and stores that information as historical data or to use in limiting or permitting further access to the game console or other play activities within a certain time period. For example, the supervised user may be permitted a maximum time of 10 hours on the game console over a period of a week.

In some embodiments of system 100, monitoring device 110 and computing devices 125, 130 allow two way voice communications between users of those devices. This is particularly advantageous where a supervised user may wish to communicate with the supervisor about an issue they are experiencing in the use of the computing device 125, 130 or where the supervisor may wish to guide the supervised user in a particular direction regarding that supervised users activity or any inappropriate content they may be viewing. Such voice communication may be effected through a voice over internet protocol (VoIP) connection established between the monitor device 110 and a specific computing device 125, 130. As is shown in FIGS. 8 to 11, a user selectable option 922 is displayed in a small toolbar or control bar 910 in a part of the display of the computing device 125, 130 or a part of each view port 705, 710, 715 (FIG. 7) displayed on display 312 on the monitoring device 110. In some embodiments, the monitoring device 110 or computing device 125, 130 may initiate a VoIP call via the WLAN hub 120 or the communication may be more of a walkie-talkie style sequence of separate and alternating one-way voice messages rather than a VoIP call. Alternatively or in addition, text messages may be exchanged via the WLAN hub 120 between the monitoring device 110 and the most actively used device 125, 130, as described above.

In some embodiments, text messages and voice calls or messages can be exchanged between different users of computing devices 125, 130 that are present (in a software sense) in the same shared local network, such as a home network or LAN 115. For example, siblings working on their homework at home using computing devices 125, 130 in the same network may wish to message each other and can interact with the I/O control module 280 of the software agent 250 on their respective devices 125 or 130 to effect such messaging. The monitoring device 110 may be configured to capture and display the participating users that are exchanging text messages, the message times and optionally the contents of such messages being exchanged between the devices 125, 130.

In some embodiments, messages may also be exchanged through the software agents 250 of devices 125 of two or more users that are registered with the home LAN 115 but that are connected to networks that are external to LAN 115.

In some embodiments, the software agent 250 of a computing device 125, 130 can be used to allow supervised text messaging between a user of computing device 125, 130 and friends on external networks that are not registered with the home LAN 115. Such messages can be exchanged via a secure registry on the server 160. In order to initiate such messaging, the external user will need to be invited by the user of supervised computing device 125, 130. This invitation can be effected by selection of a suitable “invite friend to message” option presented by the I/O control module 280. In response to such a selection, the software agent 250 causes an email or other electronic message to be generated to the friend's email address or other contact address (as input by the user). The friend is then sent an encrypted token link which, when activated, adds a unique user identifier (of the invitee) and network location (of the invitee) to the user record of the inviter to a data store accessible to the server 160, so that the invitee is recorded by the server 160 as a trusted friend. The friend's name is then added to a directory of trusted friends permitted to exchange messages with the inviting user. An advantage of this process is that a young supervised user can be allowed to exchange messages with trusted friends and the supervising user can monitor messaging communications with the supervised user and ascertain with whom the supervised user is exchanging messages.

At setup of system 100, the monitoring device 110 may undergo a device discovery process in which it discovers other devices, such as computing devices 125, 130 and game consoles 135 that are in the WLAN and connected to the WLAN hub 120. For each such discovered device, the monitoring device will try to determine whether a software agent 250 is installed and executing on that computing device. The monitoring device 110 then has an option to register each detected software agent 250, such that each software agent 250 will only allow user activity monitoring by (and screen image transmission to) the recognised and registered monitoring device 110.

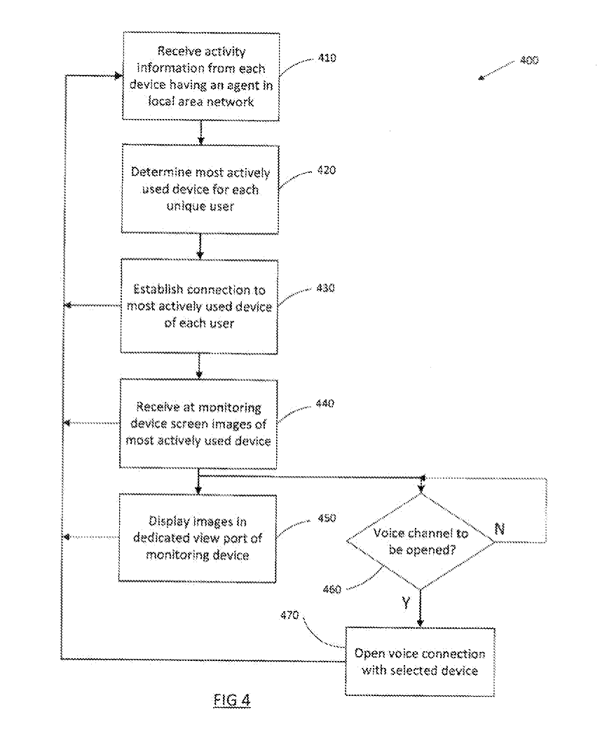

Referring also to FIG. 4, a method 400 of monitoring user activity is described in further detail. Method 400 may be performed continuously, whereby each of steps 410 to 470 is continuously performed individually and the steps are performed in sequence. Method 400 is illustrative of the monitoring method as seen from the perspective of the monitoring device 110, as opposed to the monitored computing devices 125, 130.

Method 400 begins at step 410, when the monitoring device 110 receives status signals (which at the least include watchdog signals to indicate that the software agent 250 is active and functioning and may also include user activity status signals) from each computing device 125, 130 having an agent 250 installed and executing thereon, assuming that the computing device 125, 130 is turned on. The agent 250 continually monitors the user activity of the computing device 125, 130 and, in some embodiments, may provide output messages to the monitoring device 110 to indicate the level and/or type of activity that has been detected by the agent 250 in relation to the particular computing device 125, 130. If no activity is detected, the agent 250 still regularly pings (transmits) to the monitoring device a message to indicate this. The status signals thus received by the monitoring device 110 to indicate user activity may be in any suitable message format. In other embodiments, the active device selection module 360 may determine the level of user activity at least partly from streamed data. In some embodiments, each apparently actively used computing device 125, 130 (to which the same user is logged on) may stream its images to the monitoring device 110 constantly in order to provide the monitoring device 110 with the necessary user activity data to determine which device is most actively used and the monitoring device 110 only displays the display images of the device determined to be most actively used. However, this is less preferred than embodiments that request streaming of the display images only from the one device that is considered to be most actively used.

In described embodiments, it is preferred that the monitoring device 110 only request from the computing devices 125, 130 (and the software agents 250 executing on such devices are configured to only transmit) those portions of images on the display 214 that have changed from the previous streamed image. This advantageously minimises the demand on communication and computing resources within system 100.

At 420, the monitoring device 110 determines the most actively used device of a particular user, where that user is logged on to more than one computing device 125, 130 in the LAN 115 (as reported by the agent 250). The active device selection module 360 compares the activity detected on the computing devices 125, 130 by the agents 250 (and described in messages sent to monitoring device 110) and determines based on that information which of the computing devices 125, 130 is, according to a set of rules stored in memory 330, considered to be the most actively used device. Such rules may specify that a particular activity is deemed to be a more active use of the computing device 125, 130 than another type of activity. For example, a video call may be considered to be a more active use of a computing device than simply watching a video.

Where the active device selection module 360 receives data indicating that two or more computing devices 125, 130 are each as actively used as the other, then criteria other than the type of activity may be applied to determine which computing device 125, 130 is the most actively used. For example, if two computing devices 125, 130 indicate the same activity, but one of those devices also indicates output from one or more accelerometers present in the device, then that device may be considered to be the most actively used computing device. In another example, if the activity is received from a particular type of computing device, this may rank higher than similar activity on other types of computing devices.

At 430, if the most actively used computing device 125, 130 is a different computing device to one with which a monitoring connection is already established, then the monitoring device 110 establishes a virtual network computing (VNC) connection with the computing device 125, 130 determined to be the most actively used device. Once the VNC connection is established, then at 440 the computing device 125, 130 transmits to the monitoring device 110 images displayed on display 214 to the user of that computing device. These images are then displayed on display 314 on the monitoring device 110 at 450.

For a computing device that is actively monitored by monitoring device 110, the monitoring device 110 allows a voice channel to be opened between the monitoring device 110 and the computing device 125, 130, upon user selection of a selectable icon 922 (on a computing device 125, 130) or 1030 (on the monitoring device 110). If at 460 a voice channel is thus opened, then at 470 a voice connection, such as a VOIP connection, is established between the two devices and the users may speak with each other.

Referring now to FIG. 5, a method 500 of dynamic switching of a personal computing device between a local mode and a remote mode is described. Method 500 begins at 510, in which the personal computing device 125 or 130 (if it is a laptop but not a desktop) determines whether it is within the home local area network (eg LAN 115) and whether the monitoring device 110 is also present within the home network. If at 520 it is determined that both the personal computing device 125/130 and the monitoring device 110 are present and connected within the LAN 115, then at 530 the personal computing device 125/130 adopts a local communication mode, in which it will stream display images to the monitoring device 110 if it is the most actively used device. In the local mode, the agent 250 of the personal computing device 125/130 monitors user activity at 535 and provides status information to the monitoring device 110, including image data, if appropriate at 540. Where the personal computing device 125/130 has previously cached user activity data, for example because it was previously outside the home network and has recently re-entered it, then the user activity tracking and reporting module 260 sends such cached data to the monitoring device 110.

If at 520 it is determined that either or both of the personal computer device 125/130 and a monitoring device 110 are outside of the home network, then the software agent 250 causes the personal computing device 125/130 to adopt a remote communication mode at 550. In the remote mode, the software agent 250 determines via the communications module 220 at 560 whether a mobile (ie data over mobile telephony) or WIFI (ie a local area network) data connection is available. If no such data connection is available, then at 565, the software agent 250 continues to monitor use activity of the personal computing device 125/130 and locally caches data about the user activity for later provision to the monitoring device 110.

If at 560 it is determined that a mobile or WIFI data connection is available, then at 570, the personal computing device 125/130 establishes a connection to the remote server 160 in a known manner at 570 and the software agent 250 continues to monitor the user activity at 580 and send user activity to the monitoring device 110 via the remote server 160. The user activity data thus transmitted from the personal computing device 125/130 to the monitoring device 110 is preferably performed in a way that minimises or otherwise optimises cost and/or communications bandwidth while still meeting configured monitoring requirements. Such user activity may also be transmitted at relatively infrequent intervals, such as every minute or several minutes or fraction of an hour, in contrast with the constant monitoring that would occur in the home network.

Turning now to FIG. 6, there is shown in method 600 of dynamically switching the monitoring device 110 between a local mode and a remote mode. Method 600 begins at 610, in which the monitoring device 110 determines for each personal computing device 125, 130 that is registered to be monitored by monitoring device 110 whether that personal computing device 125, 130 is within the home network or was within the home network when it was last switched on. The monitoring device 110 first determines whether it is within the home network and, if not, then at 640 the monitoring device 110 automatically adopts a remote mode of operation. Otherwise at 620, if the monitoring device 110 determines that it is within the home network and a particular personal computing device 125, 130 is also within the home network, then the monitoring device 110 adopts a local mode of operation at step 630 with respect to that personal computing device 125, 130. Where both the monitoring device 110 and a particular personal computing device 125, 130 are both operating in local mode, then method 400 is performed as previously described to allow streaming of display images from the personal computing device 125, 130 to the monitoring device 110.

For each personal computing device 125, 130 that the monitor 110 determines is outside of the home network, then the monitoring device 110 adopts a remote mode in relation to each such personal computing device 125, 130 at 640. If at 650 the monitoring device 110 determines that a mobile or WIFI data connection is not available, then the monitoring device 110 returns to 610 and checks it status again after a waiting period, such as a number of minutes. Otherwise, if a mobile or WIFI data connection is available at 650, then the monitoring device 110 establishes a connection to the remote server 160 at 660 via known secure connection methods. The monitoring device 110 then queries the status of remotely monitored personal computing device 125, 130 via the remote server 160 at 670 and requests user activity data to be transmitted to the monitoring device 110 via the remote server 160, where the particular personal computing device 125, 130 is determined to be the most activity used device to which the supervised user is logged on.

Both methods 500 and 600 may be performed regularly and periodically or may be performed in response to automatic detection of entry into or exit from the home network.

Thus, in the described manner, the monitoring device 110 and each personal computing device 125, 130 (other than immovable desktop computers) can dynamically switch between different operating modes that use different methods and communication processes to allow monitoring of user activity.

In order to detect whether the monitoring device 110 is in the home LAN 115, whether it is by 802.11 wireless WiFi connection or Ethernet cabled connection, or if it is in the public networks 140, a network detection test may be performed, as described below.

A machine access control (MAC) address of the WLAN hub 120 is available using an address resolution protocol (ARP) request for the gateway IP address that is provided when the computer connects to the network. (The command in DOS is arp -a <IP ADDRESS OF GATEWAY>). Programmatically, this can be done using a library similar to that used to detect user activity on the game console 135, as previously described.

The ARP request should result in a reply message that contains the MAC address of the WLAN hub 120 that the computing device 110, 125, 130 is connected to. If the received MAC address matches one of the known MAC address for the home LAN network 115, then the monitoring device 110 is determined to be at the home network.

When the software agent 250 and the monitor 350 first connect to each other, the MAC address of the WLAN hub 120 is added to a list in the configuration file for later comparison. The described communication protocol between the monitor and the software agent can only operate on the local network as the broadcast messages from the software agents 250 do not get forwarded across the router's internet connection. The broadcast messages from the software agents 250 are also only targeted to the address of the local area network 115 subnet.

The MAC address could change if the WLAN hub 120 changes, or if the home has multiple inputs (wireless/wired), or the home has more than one router linked together; the monitoring device 110 is configured to notice this and as long as there is a local connection with a software agent 250, or the next time a software agent 250 connects using the local connection, it will update its list of known MAC addresses of the router. Some hysteresis to remove old and obsoleted entries may be employed but is not essential.

If the detected MAC address is determined by the monitoring device 110 to be different to the cached MAC address of the WLAN hub 120, then the monitoring device 110 will switch to ‘Remote’ operation mode.

In some embodiments, communications between the monitoring device 110 and the computing devices 125, 130 may be proxied via the internet over a secure tunnel. In such embodiments, the secure tunnel will indicate that the connection is going via a remote connection as it establishes the external IP address of the WLAN hub 120 and the location server 160 in the server cloud infrastructure will know the last-known IP address of the home network and compare it to the IP address of any software agents 250 connecting through the secure tunnel.

Referring now to FIG. 7, an example screen image 700 is shown of the display 314 of monitoring device 110. As is shown in FIG. 7, the screen image 700 is divided into separate view ports corresponding to separately monitored users. For example, a first view port 705 is shown in the top right portion of the display 314, a second view port 710 is shown in the top left section of the display 314 and a third view port 715 is shown in the bottom half of the display 314. Each view port 705, 710, 715 displays exact images, reduced resolution images or generally approximate images of what a particular monitored user is viewing on the computing device 125, 130 that is considered by the active device selection module 360 to be the most actively used computing device. Overlayed on the monitored screen imagery in each view port 705, 710, 715 are name fields 725 to indicate which user's display is shown in the particular view port as well as a title of the document, application, website or media being viewed by the user whose screen imagery is being displayed in that view port. This title may be overlayed across a central part of the view port 705, 710, 715 in a banner 730, for example as shown in FIG. 7.

Each view port 705, 710, 715 has an options window 720 (shown in more detail in FIG. 10) positioned to one side of, and possibly in the corner of, each view port. This options window 720 provides information, for example in the form of the number of hours spent online or spent on a particular activity, indicated by timer 1020 in FIG. 10. The options window 720 further comprises a communication icon that is selectable in order to initiate voice communication with the user whose activity is being viewed in the view port. Additionally, the options window comprises a selectable option 1040 to maximise or reduce the size of the view port. Further, a menu toggle 1050 is provided in order to provide further options and allow configuration. Such further options may include a messaging function, for example.

As shown in FIG. 10, the options window 720 also includes a status icon 1060 that changes to indicate a change in connection status with devices used by the user monitored via the particular view port in which the options window 720 is positioned. For example, the status icon 1060 may comprise a check icon if the status is ok, or it may show a cross icon if the user is not logged in or a question mark icon if the monitoring device 110 is not receiving imagery from the relevant computing device 125, 130.

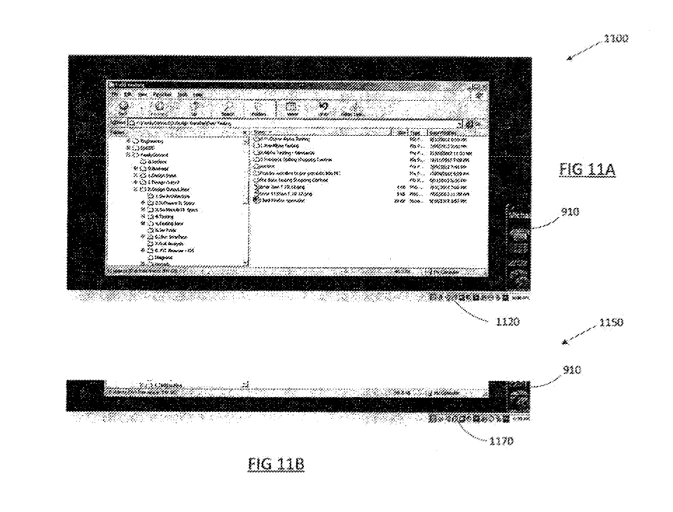

As shown in FIGS. 9A, 9B, 11A and 11B, a control bar or options window 910 is displayed as part of a user display 900 (FIG. 9A) or 950 (FIG. 9B) to indicate to the supervised user that the software agent 250 is installed and executing on the personal computing device 125, 130 that is being used. The options window 910 may be semi-transparent and positioned in a corner or along a side, top or bottom region of the display 214. The options window 910 may include an indication or identification 920 of a logged on user's name, an intercom button 922, a detected activity type indicator 924, a timer 926 and a configuration panel button 928. The intercom button 922 may be selected in order for the supervised user to open a voice communication or messaging session with the supervising user on monitoring device 110. The detected activity type indicator 925 may display a positive indication for a learning activity or a neutral or negative indication for a play activity, for example. A neutral or negative indication 954 is shown in display 950. The timer 926 may be used to display the amount of accrued play activity or learning activity, for example.

The display window 910 may be minimised by the supervised user. Whether or not the display window 910 is minimised, an icon may be displayed in a suitable location on display 214, for example in a lower or side icon bar, to indicate whether the personal computing device 125, 130 is being actively monitored. For example, as shown in FIGS. 11A and 11B, an icon 1120 in one state may be shown as part of display 1100 to indicate to the supervised user that the particular personal computing device 125, 130 that is being viewed is being actively monitored by the monitoring device 110 and display images from that personal computing device 125, 130 are being provided monitoring device 110. Where the particular personal computing device 125, 130 being viewed is not considered by the monitoring device 110 to be the most actively used device, then a modified or different display icon 1170 may be displayed in display 1150 instead of the icon 1120 that indicates active monitoring. The difference in icon appearance may be as simple as a change in colour or other change that visually emphasises or de-emphasises that icon.

Embodiments have been described generally herein by way of non-limiting example. Thus, this detailed description should be taken as illustrative and not restrictive, taking into account that some variation or modification of the described embodiments is possible without departing from the spirit and scope of the invention or inventions described herein.

What is claimed is:

1. A system for monitoring user activity on a plurality of networked devices, the system comprising:
a central monitoring device comprising a monitor display and capable of wireless communication over a network;
a plurality of personal computing devices, each comprising a display and being capable of communication with the central monitoring device over the network, each personal computing device being associated with a supervised user and comprising a software agent executing on the computing device when the personal computing device is powered on;
wherein each software agent is configured:
to monitor user activity of the personal computing device on which it is executing,
to transmit user activity data to the central monitoring device when the personal computing device is in use, and
to transmit to the central monitoring device display images from the display of the personal computing device;
wherein display images received by the central monitoring device from one or more of the personal computing devices are displayed on the monitoring display.

2. The system of claim 1, wherein the plurality of personal computing devices comprises at least two personal computing devices associated with a same supervised user, and wherein the central monitoring device is configured to determine from user activity data received from each of the at least two personal computing devices which one of the at least two personal computing devices is most actively used.

3. The system of claim 2, wherein each software agent is configured to transmit the display images to the central monitoring device in response to a request for the display images and the central monitoring device is configured to transmit the request for the display images to the software agent of the one of the personal computing devices that is determined to be most actively used.

4. The system of claim 2 or claim 3, wherein the central monitoring device is configured to display on the monitor display the display images received from the one personal computing device associated with the same supervised user determined to be most actively used.

5. The system of any one of claims 1 to 4, wherein each software agent and the central monitoring device are configured to communicate using virtual network computing (VNC).

6. The system of any one of claims 1 to 5, wherein each software agent is configured to compress and optionally scale the display images prior to transmitting them to the central monitoring device.

7. The system of claim 6, wherein the central monitoring device is configured to monitor system performance and is configured to instruct a software agent that is transmitting display images to perform lossy compression when the central monitoring device determines that system performance is degraded or is at risk of becoming degraded.

8. The system of any one of claims 1 to 7, wherein the central monitoring device and/or each software agent are configured to operate in one of a local mode or a remote mode, depending on whether the central monitoring device and the respective software agent are detected to be both connected to a home network.

9. The system of claim 8, wherein in the local mode, a respective software agent transmits the display images as a streaming display to the central monitoring device and in the remote mode, the central monitoring device receives a periodic update of display information indicative of user activity occurring at the personal computing device on which the respective software agent is executing.

10. The system of any one of claims 1 to 9, wherein each software agent is configured to classify monitored user activity as play activity, learning activity or another activity.

11. The system of any one of claims 1 to 10, wherein the central monitoring device is configured to display on the monitor display a descriptor associated with received display images based on received user activity data, wherein the descriptor may include one of: an activity descriptor, a game console name, a game title, a file title, an application title, a web page title, a uniform resource indicator, a file path name and a file name.

12. The system of claim 11, wherein the descriptor is displayed or displayable in a banner across a part of a view port through which the received display images are displayed on the monitor display.

13. The system of any one of claims 1 to 12, wherein the central monitoring device is configured to display a supervised user name in relation to a view port through which images received from a personal computing device associated with a respective supervised user are to be displayed if received.

14. The system of any one of claims 1 to 13, wherein the central monitoring device is configured to operate in a local mode when the central monitoring device is within a home local area network, the system further comprising a game console in communication with the home local area network, wherein the central monitoring device is configured in the local mode to monitor communications from the game console over the home local area network and to determine from the monitored communications whether the game console is in active use.

15. The system of any one of claims 1 to 14, further comprising a server in communication with the central monitoring device over the network, the server being configured to act as a communication gateway, either by passing data or establishing a peer-to-peer connection between the central monitoring device and one or more of the personal computing devices when the central monitoring device or the one or more personal computing devices are outside of a home local area network.

16. The system of any one of claims 1 to 15, wherein the central monitoring device and each software agent are configured to enable establishment of a voice call between the central monitoring agent and the personal computing device on which a respective software agent is executing.

17. The system of claim 16, wherein the central monitoring device is configured so that, when a same supervised user is determined by the central monitoring device to be concurrently logged on to multiple personal computing devices, the central monitoring device routes a voice call initiated from the central monitoring device to that supervised user to one personal computing device associated with the same supervised user that is determined by the central monitoring device to be most actively used.

18. The system of claim 16 or claim 17, wherein when the central monitoring device and the personal computing device on which a respective software agent is executing are both in a same local area network, the central monitoring device and respective software agent are configured to establish the voice call by establishing a voice-over-internet protocol connection.

19. The system of any one of claims 1 to 18, wherein the personal computing devices comprise personal computing devices associated with different supervised users and wherein the monitor display comprises a view port associated with each different supervised user, each view port to display received display images from a personal computing device associated with a respective supervised user.

20. The system of claim 2 or any one of claims 3 to 19 when dependent on claim 2, wherein the central monitoring device and each software agent are configured to enable transmission of text messages via a shared local network between the central monitoring device and the personal computing device that is determined to be most actively used.

21. The system of any one of claims 1 to 20, wherein the plurality of personal computing devices comprises at least two personal computing devices associated with a same supervised user, and wherein the central monitoring device is configured to determine from user activity data received from each of the at least two personal computing devices which one of the at least two personal computing devices is most actively used and to switch or not switch between display images of the at least two personal computing devices so that images displayed in the monitor display are images received from the personal computing device determined to be most actively used.

22. The system of claim 21, wherein the central monitoring device applies a short time delay to switching between display images of the at least two personal computing devices.

23. A monitoring device for monitoring user activity on a plurality of networked devices, the monitoring device comprising:
a wireless communication sub-system for local area network communication;
an image display;
at least one processor; and
memory storing program code executable by the at least one processor to cause the monitoring device to:
receive user activity data from a software agent executing on each of a plurality of personal computing devices in local area network communication with the monitoring device, the user activity data being indicative of use of the respective personal computing device by a supervised user,
receive from at least one of the personal computing devices display images from a display of the at least one personal computing device, and
display in at least a part of the image display the display images received from the at least one personal computing device.

24. The monitoring device of claim 23, wherein the plurality of personal computing devices comprises at least two personal computing devices associated with a same supervised user, and wherein the monitoring device is configured to determine from user activity data received from each of the at least two personal computing devices which one of the at least two personal computing devices is most actively used.

25. The monitoring device of claim 24, wherein the code is executable to cause the monitoring device to enable transmission of text messages via a shared local network between the monitoring device and the one personal computing device that is determined to be most actively used.

26. The monitoring device of claim 25, wherein the monitoring device receives the display images in response to a request for the display images and the monitoring device is configured to transmit the request for the display images to the software agent of the one of the personal computing devices that is determined to be most actively used.

27. The monitoring device of any one of claims 24 to 26, wherein the monitoring device is configured to display on the monitor display the display images received from the one personal computing device associated with the same supervised user determined to be most actively used.

28. The monitoring device of any one of claims 23 to 27, wherein the monitoring device is configured to communicate with each software agent using virtual network computing (VNC).

29. The monitoring device of any one of claims 23 to 28, wherein the monitoring device receives compressed display images from each personal computing device and is configured to decompress the compressed display images.

30. The monitoring device of claim 29, wherein the monitoring device is configured to monitor system performance across the plurality of networked devices and is configured to instruct a software agent that is transmitting display images to perform lossy compression and optionally automatically scale transmitted display images when the monitoring device determines that system performance is degraded or is at risk of becoming degraded.

31. The monitoring device of any one of claims 23 to 30, wherein the monitoring device is configured to operate in one of a local mode or a remote mode in relation to communication with each personal computing device, depending on whether the monitoring device and the respective software agent of a personal computing device are detected to be both connected to a home network.

32. The monitoring device of claim 31, wherein in the local mode, the monitoring device receives the display images from at least one of the personal computing devices as a streaming display, and in the remote mode, the central monitoring device receives a periodic update of display information indicative of user activity occurring at the personal computing device on which the respective software agent is executing.

33. The monitoring device of any one of claims 23 to 32, wherein the monitoring device is configured to display a descriptor associated with received display images based on received user activity data, wherein the descriptor may include one of: an activity descriptor, a game console name, a game title, a file title, an application title, a web page title, a uniform resource indicator, a file path name and a file name.

34. The monitoring device of claim 33, wherein the title is displayed or displayable in a banner across a part of a view port through which the received display images are displayed on the monitor display.

35. The monitoring device of any one of claims 23 to 34, wherein the monitoring device is configured to display a supervised user name in relation to a view port through which images received from a personal computing device associated with a respective supervised user are to be displayed if received.

36. The monitoring device of any one of claims 23 to 35, wherein the monitoring device is configured to operate in a local mode when the monitoring device is within a home local area network, and to detect whether a game console is in communication with the home local area network, wherein the monitoring device is configured in the local mode to monitor communications from the game console over the home local area network and to determine from the monitored communications whether the game console is in active use.

37. The monitoring device of any one of claims 23 to 36, wherein the monitoring device is in communication with a remote server over the network, the server being configured to act as a communication gateway, either by passing data or establishing a peer-to-peer connection between the monitoring device and one or more of the personal computing devices when the central monitoring device or the one or more personal computing devices are outside of a home local area network.

38. The monitoring device of any one of claims 23 to 37, wherein the monitoring device is configured to enable establishment of a voice call between the monitoring agent and at least one of the personal computing devices on which a respective software agent is executing.

39. The system of claim 38, wherein the central monitoring device is configured so that, when a same supervised user is determined by the central monitoring device to be concurrently logged on to multiple personal computing devices, the central monitoring device routes a voice call initiated from the central monitoring device to that supervised user to one personal computing device associated with the same supervised user that is determined by the central monitoring device to be most actively used.

40. The monitoring device of any one of claims 23 to 39, wherein the personal computing devices comprise personal computing devices associated with different supervised users and wherein the monitor display comprises a view port associated with each different supervised user, each view port to display received display images from a personal computing device associated with a respective supervised user.

41. The monitoring device of any one of claims 23 to 40, wherein the plurality of personal computing devices comprises at least two personal computing devices associated with a same supervised user, and wherein the monitoring device is configured to determine from user activity data received from each of the at least two personal computing devices which one of the at least two personal computing devices is most actively used and to switch or not switch between display images of the at least two personal computing devices so that images displayed on the monitor display are images received from the personal computing device determined to be most actively used.

42. The monitoring device of claim 41, wherein the monitoring device applies a short time delay to switching between display images of the at least two personal computing devices.

43. A personal computing device comprising:
a wireless communication sub-system for local area network communication;
an image display;
at least one processor; and
memory storing program code executable by the at least one processor to implement a software agent program, the software agent program configured to:
monitor user activity in relation to the personal computing device,
transmit to a monitoring device display images from the image display when monitored user activity indicates active use of the personal computing device by a supervised user, and
display in at least a part of the image display a graphical indication that user activity on the personal computing device is being monitored by the software agent program and the monitoring device.

44. A method of user activity monitoring by a monitoring device having an image display, the method comprising:
receiving user activity data from a software agent executing on each of a plurality of personal computing devices in local area network communication with the monitoring device, the user activity data being indicative of use of the respective personal computing device by a supervised user;
receiving from at least one of the personal computing devices display images from a display of the at least one personal computing device; and
displaying in at least a part of the image display the display images received from the at least one personal computing device;
wherein the plurality of personal computing devices comprises at least two personal computing devices associated with a same supervised user, and wherein the monitoring device determines from user activity data received from each of the at least two personal computing devices which one of the at least two personal computing devices is most actively used, and wherein the displaying comprises displaying on the image display the display images received from the one personal computing device associated with the same supervised user determined to be most actively used.

45. A method of establishing voice communication between an originating device and one of a plurality of personal computing devices, the method comprising:
receiving at the originating device user activity data from a software agent executing on each of the plurality of personal computing devices, the user activity data being indicative of use of the respective personal computing device by a supervised user, wherein the plurality of personal computing devices comprises at least two personal computing devices associated with a same supervised user;
receiving input at the originating device to establish voice communication between the originating device and the supervised user;
determining, by the originating device, which one of the at least two personal computing devices is most actively used based on user activity data received from each of the at least two personal computing devices; and
establishing voice communication between the originating device and the one personal computing device associated with the same supervised user determined to be most actively used.

46. A method of establishing voice communication between an originating device and one of a plurality of personal computing devices, wherein the plurality of personal computing devices comprises at least two personal computing devices associated with a same supervised user, the method comprising:
receiving input at the originating device to establish voice communication between the originating device and the supervised user;
determining, by the originating device, which one of the at least two personal computing devices is most actively used based on user activity data obtained in relation to each of the at least two personal computing devices; and
establishing voice communication between the originating device and the one personal computing device associated with the same supervised user determined to be most actively used.

47. Computer-readable storage storing executable program code to implement the method of any one of claims and 44 to 46 or to implement the system or device of any one of claims 1 to 43.

48. The steps, processes, modules, features, elements, acts, compositions, architecture, components, examples, arrangements and structure described or depicted herein, individually or in any combination or sub-combination thereof.
